(19) United States
(12) Patent Application Publication
(10) Pub. No.: US 2005/0172889 A1
(43) Pub. Date: Aug. 11, 2005

(54) Coating blade and method of preparing the same

(76) Inventors: Gunter Bellmann, Commugny (CH); Silvano Freti, Senaugin 12 (CH)

Correspondence Address: BURNS DOANE SWECKER & MATHIS L L P, POST OFFICE BOX 1404, ALEXANDRIA, VA, 22313-1404, US

(21) Appl. No.: 10/520,181

(22) PCT Filed: Jul. 11, 2003
(86) PCT No.: PCT/EP03/07552

(30) Foreign Application Priority Data
Jul. 15, 2002 (SE) 0202200-2

(51) Int. Cl. B05C 11/02

(52) U.S. Cl. 118/123

(57) ABSTRACT

A coating blade for the application of coating color onto a travelling web, the blade having an edge section with a profile conformed to the surface of the web when in engagement therewith is provided. The coating blade is characterized by a sacrificial layer covering at least the edge section and protecting the underlying edge section during the web loading phase. The invention also relates to a method of preparing a coating blade by applying a film forming solution onto an edge section of the blade, and allowing the solution to dry so as to form a solid film.

The present invention relates to coating blades for the application of coating colours onto travelling webs, and the invention also involves a method of preparing such coating blades.

### BACKGROUND OF THE INVENTION

Steel blades as well as hard-tipped blades from materials such as the ceramic or metal matrix composite families, or soft-tipped elastomer blades are subject to dry friction against moving uncoated or precoated dry paper during the loading of the blade against the web. The time elapsed between the moment the blade comes into contact with the moving dry web and the arrival of the coating color at the blade is, depending on the paper machine, roughly between 1 and 5 seconds. With modern off-line coating machines, the web speed during the blade loading procedure can be as high as 700 m/min or above, which represents a dry friction length of 12 to nearly 60 meters.

Depending on the friction coefficient of the blade material, the blade loading angle or pressure against the web and the nature of the fibres and pigments of the base paper, dry friction can have dramatic consequences on the surface characteristics of the blade material. For instance the carefully ground bevels of the elastomer of a soft-tipped blade can be completely destroyed (burnt) during this step, and even the hard materials of the hard-tipped blade can be marked with groves which may have a negative effect on the coating quality. This considerable initial wear will further reduce the life-time of the blade.

Furthermore, the heat generated at the blade tip by the dry friction may be sufficient to impair correct metering of the coating color at the start of the coating process. For steel blades and hard-tipped blades where the wear resistant layer is made of metal or metal matrix composite materials, the heat generated by the dry friction is easily transmitted to some portion of the blade tip. As the opposite portion of the blade is clamped in the blade holder, the tip, which is submitted to the heat, cannot expand freely. As a consequence, the metering of the coating color can become quite uneven, and a longer time is required to get good cross section coat weight profiles. This of course impairs productivity.

It is therefore highly desirable to prevent this damaging of the blade material so that the high quality surface remains intact and available for the coating process.

Protection of the blade material from the dry friction may be achieved by lubricating the blade or the web during the loading procedure, e.g. by applying manually a lubricant onto the blade tip, or by spraying a lubricant solution directly onto the web such as for instance aqueous CMC solutions or aqueous solutions of copolymers used as rheology modifiers and water retention aids. However, this in turn requires the costly installation of a spray boom, a storage tank with pumps, or the like.

### OBJECTS OF THE INVENTION

The main object of-the invention is to provide means for reducing or eliminating dry friction between a blade and a travelling web during the web loading phase so as to increase the lifetime of the blade.

Another object of the invention is to provide such means residing in a coating blade for the application of coating color onto a travelling web while reducing or eliminating dry friction during the web loading phase.

Yet another object of the invention is to provide a coating blade provided with an edge section provided with a profile which is conformed to the surface of the web to be coated.

Still another object of the invention is to provide a method for preparing coating blades for the application of coating color onto a travelling web.

### SUMMARY OF THE INVENTION

For these and other objects which will be clear to those skilled in the art from the disclosure to follow, the invention provides for a coating blade for the application of coating color onto a travelling web, said blade having an edge section with a profile conformed to the surface of said web when in engagement therewith. The coating blade according the invention is characterised by a sacrificial layer covering at least said section and protecting the underlying edge section during the web loading phase. Said sacrificial layer is either soluble or insoluble in the coating medium constituted by the coating color formulation.

It is preferred to use such coating blade for the application of an aqueous coating color, wherein said sacrificial layer is soluble in water and otherwise compatible with the coating color.

The sacrificial layer is preferably substantially non-hygroscopic so as to avoid otherwise rapidly increasing friction.

The sacrificial layer is suitably constituted by a material selected from water-soluble polymers and polysaccharides capable of forming a film.

The polysaccharides may be either natural polysaccharides or derivatives of natural polysaccharides.

Among natural polysaccharides there may be mentioned xanthan gum, guar gum, locust bean gum, pectines, carageenans, dextrans, and polyuronides such as alginates.

Among derivatives of natural polysaccharides there may be mentioned cellulose derivatives, such as carboxymethylcellulose (CMC), hydroxyethylcellulose (HEC), methylcellulose (MC), methylhydroxyethylcellulose (MHEC), and hydroxyprophylcellulose (HPC).

Other derivatives are starch derivatives, such as soluble starch, hydroxyethylstarch, hydroxypropylstarch, cationic starch, and dextrins.

Among water soluble polymers there-may be mentioned acrylic-and methacrylic-polymers and -copolymers, such as poly(meth)acrylic acid, poly(meth)acrylates, polyacryl amide, copolymers of acrylamide and (meth)acrylic acid or (meth)acrylates, copolymers of (meth)acrylic acid, (meth)acrylates and acrylonitrile.

Other water soluble polymers are vinylic and allylic polymers, such as polyallylamines and salts, polyvinyl-alcohol, polyvinylpyridine and derivatives, polyvinyl-pyrrolidone, polyvinylmethylether, poly(styrenesulfonic acid) and salts, copolymers of sytrenesulfonic acid and maleic acid and their salts.

Other polymers that may be used are polyethyleneimine, polyethyleneglycol, polyethyleneoxide, and poly(2-ethyl-2-oxazoline).

It is preferred that the polymers and polysaccharides used are film-forming so as to give a sacrificial layer constituted by a film.

Among preferred water-soluble polymers there may be mentioned acrylamide polymers and copolymers.

Among useful polysaccharides there may be mentioned hemi-cellulose, plant gums, cellulose and derivatives thereof, starch and derivatives thereof, microbial polysaccharides, algal polysaccharides, and chitosan and derivatives thereof.

Preferred polysaccharides are ethyl cellulose, hydroxyethyl cellulose and carboxymethyl cellulose.

The coating blade substrate carrying the sacrificial layer constituting the essential feature of the present invention can be any type of substrate, such as steel, steel carrying a ceramic coating and so called soft tipped blades. An example of steel substrate is carbon steel, quality UHB®, 20 C (Uddeholm, Sweden). Coating blades provided with a hard tip or a ceramic coating are disclosed in GB 2 130 924. Finally, so called soft tipped blades are disclosed in EP 0 944 438, and the preferred soft material is polyurethane.

The invention also provides for a method for preparing a coating blade for the application of coating color onto a travelling web, said blade having an edge section with a profile conformed to the surface of said web when in engagement therewith, said method comprising the following steps:
a) preparing a solution containing a material capable of forming a film on evaporation of the solvent;
b) applying said solution onto at least said section; and
c) allowing the applied solution to dry so as to form a solid film on at least said section.

Step c) preferably includes heating to an elevated temperature, and the coating solution is suitably applied in several layers with intermediate heating between the application of each layer.

To protect the blade material from dry friction the sacrificial layer is integrated in the blade concept, and applied after grinding of the blade material into the desired geometry and surface smoothness. Application of the sacrificial layer can thus be made as a final manufacturing step. The function of the sacrificial layer will be to wear down during the blade loading procedure and then disappear completely with arrival of the coating color, leaving the original blade geometry and surface quality. The requirements of such sacrificial layer can thus be summarised as follows:
The layer shall have a low friction coefficient against the travelling web, such as uncoated or precoated dry paper, and have the ability to absorb the energy of friction without melting or turning into a sticky condition;
The layer shall have good film-forming properties, show good adhesion onto the blade material, and have sufficient mechanical strength to withstand loading constraints;
Futhermore, the layer shall have good solubility in the coating color medium (such as good water solubility without being hygroscopic) so as to disappear as quickly as possible once the coating color has reached the blade;
The layer shall have good compatibility with, and be non-polluting towards the coating color.

### BRIEF DESCRIPTION OF THE DRAWING

The present invention will be described in the following with reference to the appended drawing, wherein:

FIG. 1 represents a schematic view of a coating blade according to the present invention, wherein the inventive sacrificial layer is applied onto a blade of the kind described in U.S. Pat. No. 6,312,520.

FIG. 2 represents a schematic view of another coating blade according to the present invention, wherein the inventive sacrificial layer is applied onto a typical hard-tipped blade.

FIG. 3 represents a schematic view of yet another coating blade according to the present invention, wherein the inventive sacrificial layer is applied onto a standard beveled steel blade.

### DETAILED DESCRIPTION OF THE INVENTION

Preferred sacrificial layer materials are water-soluble polymers such as acrylic copolymers or soluble cellulose derivatives. These polymers are preferentially applied as an aqueous solution in a continuous way onto the ground blade material and hot air-dried in a controlled manner to give a smooth, non-sticky dry layer. This operation can be done on 100 m coils of the blade after grinding into the desired geometry and before cutting into the desired blade length. The solutions can be applied by different techniques such as roll coating, blade coating, flow coating, casting, spraying, dipping, etc. The desired layer thickness after drying can be adjusted either through the concentration or viscosity of the solution, or by applying successive layers of the solution with intermediate drying of each individual layer. The required sacrificial layer thickness is a function of the blade loading conditions of the paper machine, e.g. web speed, loading angle (blade pressure), and of the paper quality (pulp, pigments etc.). A thickness in the range of 100 μm to 700 μm is sufficient for most loading conditions.

In another embodiment of the invention, the sacrificial materials are water insoluble, film-forming materials, applied in similar ways as the water soluble materials, but from non-aqueous solutions. Non-limitative examples of such materials are Cellulose derivatives such as Nitrocellulose, Cellulose esters (Acetate, Butyrate, etc.), Poly(meth)acrylates and their copolymers.

In yet another embodiment of the invention, the sacrificial materials are applied as a self-supporting film by means of an adhesive interlayer. Particularly suitable are adhesive tapes having a low friction coefficient against dry uncoated, or pre-coated paper web. Non-limitative examples of such materials are adhesive tapes such as MOCAP 210. (polyester tape from Mocap Ltd., having a thickness of 89 μm), SCOTCH 5480 (PTFE tape from 3M, having a thickness of 90 μm), SCOTCH 244 (paper tape from 3M, having a thickness of 80 μm).

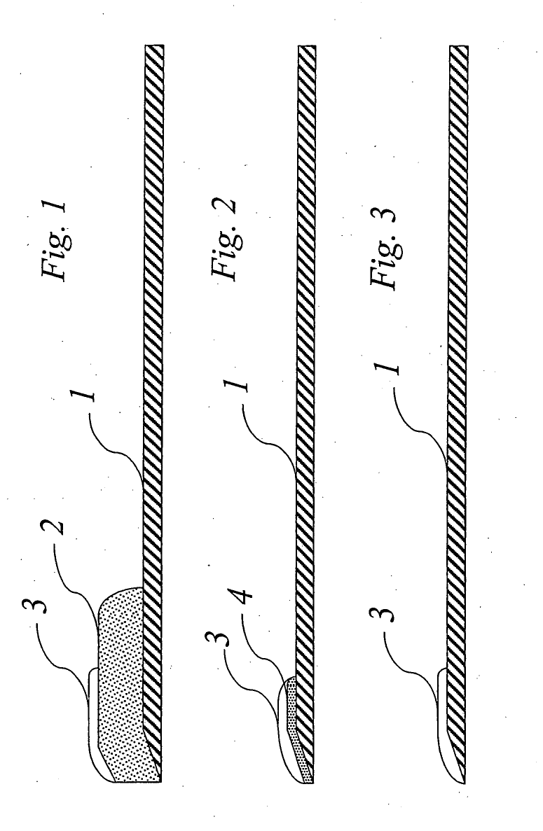

FIGS. 1 to 3 show typical coating blades which have been provided with a protective sacrificial layer according to the present invention.

FIG. 1 shows schematically a soft-tipped blade having a protective sacrificial layer according to the present invention, and comprises a steel substrate 1 supporting at its tip the soft blade material 2 with its ground bevel and part of the top section covered by a protective sacrificial layer 3 according to the present invention.

FIG. 2 shows schematically a hard-tipped blade having a protective sacrificial layer according to the present invention. The blade comprises a steel substrate 1 having a hard edge section 4. The hard edge section can be obtained in a variety of ways, such as by a ceramic coating, a metal coating or a coating of a metal matrix composite. The hard edge section is provided with the protective sacrificial layer 3 according to the present invention.

FIG. 3 shows another coating blade according to the present invention. In the shown example, a common type of beveled steel blade 1 is provided with the protective sacrificial layer 3 over its ground edge bevel.

The following examples further illustrate the invention by specific embodiments thereof. It should be noted, however, that the invention is not restricted to these examples.

### EXAMPLE 1

This and following examples relate to the application of a protective sacrificial layer on a soft-tipped coating blade such as described in U.S. Pat. No. 6,312,520 B1 and prepared according to EP 1 156 889. Such blade is schematically shown in FIG. 1. An aqueous solution of an anionic copolymer on the basis of Acrylic acid, Acrylic ester, and Acrylonitrile such as Sterocoll SL (BASF) containing 25% of solids, is applied onto the moving blade coil by means of a 0.152 mm thick steel trailing blade in such a way to form a continuous regular wet film covering the soft-tipped coating blade material, particularly the ground bevels. The water soluble copolymer is applied at a rate of 2.5 g/min using a dosing pump while the coating blade coil is moving at a speed of 1 m/min. The moving blade coil with the wet film is passed through a hot air tunnel to evaporate most of the water before it is wound up with a spacer and dried in a hot air oven at 60° C. for 2 h. The tacky free shiny layer obtained this way has an average thickness of 9 μm.

### EXAMPLE 2

The procedure of example 1 is repeated several times using each time the same coating blade coil with the applied-protective layer(s), so as to build up a multi-layer protective film, adding a thickness of 90 μm to each previous layer. Thus a 2 layer film had a thickness of 180 μm, and a 5 layer film 450 μm.

### EXAMPLE 3

A 25% aqueous solution of Sterocoll SL (BASF) was applied onto the moving coating blade coil in a similar way as in example 1 with the difference that no trailing blade was used to adjust the thickness, and the application rate was 18 g/min. After drying, the film thickness was 650 μm.

### EXAMPLE 4

A 5% aqueous solution of medium viscosity Hydroxy-ethylcellulose (Fluka Chemie, Switzerland) was applied onto the moving coating blade coil in a similar way as in example 1 with the difference that no trailing blade was used to adjust the thickness, and the application rate was 24 g/min. After drying, the film thickness was 170 μm.

### EXAMPLE 5

A 2% aqueous solution of medium viscosity Carboxy-methylcellulose (Fluka Chemie, Switzerland) was applied onto the moving coating blade coil in a similar way as in example 1 with the difference that no trailing blade was used to adjust the thickness, and the application rate was 24 g/min. After drying, the film thickness was 70 μm.

### EXAMPLE 6

A 25% aqueous solution of Sterocoll SL (BASF) was applied onto the moving coating blade coil at a rate of 19 g/min and a coil speed of 2 m/min and using a doctor knife to adjust the thickness. After drying, the film thickness was between 300 and 350 μm.

### EXAMPLE 7

A “Teflon” (PTFE) adhesive tape from 3M (Scotch 5480, 12 mm wide and 90 μm thick) was applied onto the moving coating blade coil in such a way as to form a continuous regular dry film, covering a soft-tipped coating blade such as described in U.S. Pat. No. 6,312,520, and schematically shown in FIG. 1. The tape was applied at a speed of 5 m/min with the help of a pressure roll to prevent any air from being entrapped between the blade material and the tape, and to ensure a complete and precise covering of the ground blade bevels. In a similar way, adhesive tapes made from the following materials were applied: Polyester tape Mocap 210, Paper tape 3M 244.

### EXAMPLE 8

This and following example 9 relate to the efficiency of the sacrificial layer in protecting the coating blade material against the consequenses of dry friction. An industrial pilot coater (Beloit S-matic) was used for this purpose: the coating blade with its sacrificial layer was loaded against uncoated paper (mechanical pulp, 48 g/m²) and without coating color, under various conditions of loading angle, pressure, web speed and time. Different conditions of dry friction between the coating blade and the travelling web are realized in this way. After the test, the residual sacrificial layer of the blade is then removed by dissolution in water, and the width of the blade bevel compared to the original bevel of a reference blade without sacrificial layer. In this example, the sacrificial layer was applied to the coating blades under conditions of example 3, providing a protective film having a thickness of 650 mm.

TABLE 1
Dry friction tests

| | | | | | Width of bevel |
|---|---|---|---|---|---|
| | | | | | (after removal |
| | | | | | of the residual |
| Trial | Duration | Speed | Loading | Pressure | sacrificial |
| No | [s] | [m/mn] | angle | [bar] | layer) |
| 1 | 6 | 100 | 1.5 | 0.75 | 550 μm |
| 2 | 13 | 100 | 1.5 | 0.60 | 550 μm |
| 3 | 13 | 300 | 1.5 | 0.25 | 550 μm |
| 4 | 13 | 300 | 3.0 | 0.64 | 550 μm |
| 5 | 13 | 500 | 5.0 | 1.21 | 575 μm |
| 6 | 13 | 300 | 3.0 | 0.58 | 575 μm |
| 7 | 13 | 700 | 3.0 | 0.45 | 650 μm |
| Ref | — | — | — | — | 550 μm |

Results of table 1 show that a 100% protection of the soft-tipped blade bevel was realized under conditions of trials No 1-4. In trials No 5 and 6, the increase of web speed and blade pressure was such that the sacrificial layer was worn away and the width of the blade bevel was very unsignificantly increased (+25 μm), still providing a good protection of the blade. Trial No 7 shows the limiting loading conditions where the blade protection is no more assured.

### EXAMPLE 9

In this example, the sacrificial layer was applied to the coating blade under conditions of example 4, providing a protective film layer with a thickness of 70 μm. The blades were tested with the same equipment, raw materials, and under similar conditions as mentioned in example 8. Results in table 2 demonstrate a good blade protection under conditions of trials No 8-11, whereas under the condition of trial No 12, a good protection is no more assured.

TABLE 2
Dry friction tests

| | | | | | Width of bevel |
|---|---|---|---|---|---|
| | | | | | (after removal |
| | | | | | of the residual |
| Trial | Duration | Speed | Loading | Pressure | sacrificial |
| No | [s] | [m/mn] | Angle | [bar] | layer) |
| Ref | — | — | — | — | 550 μm |
| 8 | 13 | 100 | 1.5 | 0.15 | 550 μm |
| 9 | 13 | 300 | 3.0 | 0.61 | 550 μm |
| 10 | 13 | 300 | 5.0 | 1.23 | 550 μm |
| 11 | 13 | 500 | 3.0 | 0.58 | 550 μm |
| 12 | 13 | 700 | 3.0 | 0.38 | 675 μm |

### EXAMPLE 10

This example relates to the efficiency of the water-insoluble sacrificial layer in protecting the coating blade material against the consequences of dry friction. A laboratory equipment simulating dry friction against a sheet of uncoated paper was used for this purpose. The sheet of uncoated paper (G-print, 66 g/m² base weight, from Stora Enso) is fixed onto a small backing roll (width 10 cm, Ø 15 cm) by means of a double-sided adhesive tape. The roll is rotated at a frequency of 17.5 Hz corresponding to a circumferential speed of 495 m/min. A soft-tipped coating blade such as that described in U.S. Pat. No. 6,312,520 having a length of 9 cm and a width of 10 cm is fixed in a 10 cm wide blade holder of the ABC type (BTG Coating Systems), and the soft-tipped blade material, which is protected by a water-insoluble sacrificial layer, is applied against the rotating backing roll with a constant differential pressure of 0.5 bar during 20 sec. The width of the abraded contact area or bevel was measured and compared to a reference blade without sacrificial layer. Results in table 3 demonstrate an excellent blade protection with the Polyester and Paper tapes, and a slightly less good protection with the PTFE tape.

TABLE 3
Dry friction tests (laboratory simulation)

| | Width of | |
|---|---|---|
| | abraded area | |
| Sample | [μm] | Remarks |
| Reference (before test) | 650 | Width of initial bevel |
| Reference (after test) | 900-1200 | Highly damaged bevel |
| Mocap 210 (Polyester | 650 | Undamaged bevel after |
| tape) | | removal of film |
| 3M 5480 (Teflon tape) | 650-750 | Slightly enlarged bevel |
| 3M 244 (Paper tape) | 650 | Undamaged bevel after |
| | | removal of film |

### EXAMPLE 11

This example relates to the use of the coating blade of the invention under industrial coating conditions and a comparison with a standard coating blade. Trials are performed on a pilot board coater equipped with an ABC blade holder: precoated board of 260 g/m² was used with a web speed of 450 m/min and coating color having a solids content of 64%. The coating blades used for these trials were of the soft-tip type and were protected with a sacrificial layer of 300 μm thickness, prepared according to example 6. During loading of the blade, and before arrival of the coating color, the blades were submitted to dry friction against the moving board. After coating of the reel, the coating blade was taken out of the blade holder for examination. A reference trial with a similar blade but without sacrificial layer was run under identical conditions for comparison. Results in table 4 clearly show the benefit of the protective sacrificial layer. Examination of blades from trials 1-4 after coating one reel revealed that no residual traces of sacrificial layer were left, i.e. all unused film material had been dissolved by the coating color, and that there was no damage due to dry friction..On.the other hand, the reference trial had to be interrupted because of large streaks in the coating as a result of blade damage coming from dry friction.

TABLE 4
Pilot coating trials

| Trial | Dry friction | Sacrificial | Coating | Blade |
|---|---|---|---|---|
| No | [sec] | layer | quality | surface |
| 1 | 5 | 300 μm | Good | Undamaged |
| 2 | 10 | 300 μm | Good | Undamaged |
| 3 | 15 | 300 μm | Good | Undamaged |
| 4 | 25 | 300 μm | Good | Undamaged |
| Ref | 15 | No | Bad→Streaks | Damaged |

1. Coating blade for the application of coating color onto a travelling web, said blade having an edge section with a profile conformed to the surface of said web when in engagement therewith wherein there is a sacrificial layer covering at least said section and protecting the underlying edge section during the web loading phase, wherein said sacrificial layer is adapted to disappear, when using the blade, as a result of the arrival of the coating color at the coating blade.

2. Coating blade according to claim 1 for use in the application of an aqueous coating color, wherein said sacrificial layer is soluble in water and otherwise compatible with said coating color.

3. Coating blade according to claim 1, wherein said sacrificial layer is substantially non-hygroscopic.

4. Coating blade according to claim 1, wherein said sacrificial layer comprises a material selected from water-soluble polymers and polysaccharides capable of forming a film.

5. Coating blade according to claim 4, wherein said material is selected from acrylic or methacrylic polymers and copolymers and their salts.

6. Coating blade according to claim 4, wherein said material is selected from anionic copolymers on the basis of Acrylic acid, Acrylic ester and Acrylonitrile.

7. Coating blade according to claim 4, wherein said material is selected from film-forming polysaccharides.

8. Coating blade according to claim 7, wherein said material is selected from hemi-celluloses, plant gums, cellulose and derivatives thereof, starch and derivatives thereof, microbial polysaccharides, algal polysaccharides, and chitosan and derivatives thereof.

9. Coating blade according to claim 8, wherein said material is selected from ethyl cellulose, hydroxyethyl cellulose and carboxymethyl cellulose.

10. Coating blade according to claim 1 selected from steel blades, hard-tipped blades, and soft tipped blades.

11. A method of preparing a coating blade for the application of coating color onto a travelling web, said blade having an edge section with a profile conformed to the surface of said web when in engagement therewith, comprising the following steps for providing the blade with a sacrificial layer protecting said edge section during a web loading phase:
a) preparing a solution containing a material capable of forming a film on evaporation of solvent;
b) applying said solution onto at least said section; and
c) allowing the applied solution to dry so as to form, on at least said section, a solid film having a thickness of 100 μm to 700 μm;
wherein the sacrificial layer is adapted to disappear, when using the blade, as a result of the arrival of the coating color at the coating blade.

12. A method according to claim 11, wherein step c) includes heating to an elevated temperature.

13. A method according to claim 11, wherein the solution is applied in several layers with intermediate heating between the application of each layer.

14. A method according to claim 11, wherein under step a) an aqueous solution is prepared which contains a polysaccharide in a concentration of at most about 10% by weight.

15. A method according to claim 14, wherein said concentration is from about 1% to about 7% by weight.

16. A method according to claim 11, wherein under step a) an aqueous solution is prepared which contains an anionic copolymer on the basis of acrylic acid, acrylic ester and acrylonitrile in a concentration of at most about 40% by weight.

17. A method according to claim 16, wherein said concentration is about 15% to about 30%.

18. Coating blade according to claim 2, wherein said sacrificial layer. is substantially non-hygroscopic.

19. A method according to claim 12, wherein the solution is applied in several layers with intermediate heating between the application of each layer.

20. A method according to claim 12, wherein under step a) an aqueous solution is prepared which contains a polysaccharide in a concentration of at most about 10% by weight.

21. A method according to claim 13, wherein under step a) an aqueous solution is prepared which contains a polysaccharide in a concentration of at most about 10% by weight.

22. A method according to claim 12, wherein under step a) an aqueous solution is prepared which contains an anionic copolymer on the basis of acrylic acid, acrylic ester and acrylonitrile in a concentration of at most about 40% by weight.

23. A method according to claim 13, wherein under step a) an aqueous solution is prepared which contains an anionic copolymer on the basis of acrylic acid, acrylic ester and acrylonitrile in a concentration of at most about 40% by weight.
